(19) United States
(12) Patent Application Publication
(10) Pub. No.: US 2009/0235903 A1
(43) Pub. Date: Sep. 24, 2009

(54) AIR INTAKE SYSTEM FOR A HOMOGENEOUS-CHARGE COMPRESSION-IGNITION ENGINE

(75) Inventors: Jialin Yang, Canton, MI (US); Fang Shui, Farmington Hills, MI (US)

Correspondence Address: MERCHANT & GOULD PC, P.O. BOX 2903, MINNEAPOLIS, MN, 55402-0903, US

(73) Assignee: Shanghai Automotive Industry Corporation, Shanghai (CN)

(21) Appl. No.: 12/243,738

(22) Filed: Oct. 1, 2008

(30) Foreign Application Priority Data
Mar. 24, 2008 (CN) 200810035037.2

(51) Int. Cl. F02G 5/00

(52) U.S. Cl. 123/543

(57) ABSTRACT

The present disclosure discloses an HCCI air intake system for HEV, wherein the air outlet of the compressor is simultaneously connected to a hot channel and a cold channel, the hot channel is connected to the cylinder of the HCCI gasoline engine via the electrical drive system, coolant heat exchanger, engine exhaust heat exchanger and a throttle valve, while the cold channel is directly connected to the cylinder of the HCCI gasoline engine via another throttle valve. The hot channel is provided with at least one bypass valve for discharging air. The present disclosure makes the best use of the features of the electrical drive system and the HCCI gasoline engine in the HEV to make them technically work with each other, and provides a united air circulation system to meet the need to cool down the electrical drive system while controlling the air intake temperature of the engine cylinder, thereby overcoming the difficulty in maintaining the temperature level caused by the fact that the HCCI gasoline engine in the HEV has to be shut down intermittently. The present disclosure, in combination with its controlling method, may decrease even further, with relatively lower cost, the mean gasoline consumption and exhaust discharge of vehicles.

### FIELD OF THE INVENTION

The present disclosure pertains to the field of hybrid electrical vehicle (HEV), and in particular relates to an engine air intake system of the HEV with homogeneous charge compression ignition (HCCI) gasoline engine as its engine.

### BACKGROUND OF THE INVENTION

A solution being considered by many automobile manufacturers is to employ the homogeneous charge compression ignition (HCCI) gasoline engine on the hybrid electrical vehicle (HEV), the use of which, because of its potential to significantly improve the heat conversion efficiency of the engine, may further decrease the mean gasoline consumption of the hybrid electrical vehicle (HEV).At the same time, the HCCI gasoline engine, because of its extremely low nitrogen oxides (NOₓ) discharge that is only 1-2% that of the general gasoline engine, relieves the burden on the post-discharge processing of the HEV considerably. Otherwise, the post processing of the NOₓ may be a difficult task in the case of lean burn.

There are many different HCCI gasoline engine configurations, each of which has a different fuel efficiency. U.S. Pat. No. 6,295,973 B1 discloses an optimized kinetic process (OKP) HCCI gasoline engine system. Experiments carried out on the single cylinder engine stand demonstrate that, under a typical partial load condition (1500 rpm with the brake mean effective pressure (BMEP) being 2.62 bar), this OKP gasoline engine may improve its fuel efficiency by nearly 50% compared with the normal electronic fuel injection (EFI) gasoline engine. The oretical analysis also shows that, in an OKP gasoline engine, the partial load heat efficiency almost reaches the technical upper-limit of the piston engine. Therefore, mean gasoline consumption of the vehicle may be further decreased by applying the OKP HCCI gasoline engine to the HEV.

The ignition of HCCI occurs when the temperature of the gas mixture inside the cylinder is raised to the self ignition point. Therefore, all HCCI engines must manage to bring the gas mixture to the self ignition point near the top dead center (TDC). For example, a so-called controlled auto-ignition (CAI) HCCI gasoline engine utilizes the variation of the opening and closing time of the inlet and exhaust valve to significantly increase the amount of remaining exhaust inside the cylinder, thereby raising the temperature of the gas mixture so that it reaches the self ignition point after being compressed. OKP gasoline engines control the ignition based on the quick heat management of the intake air, wherein the intake air has two channels, namely, one air channel passes through the engine coolant heat exchanger and the engine exhaust heat exchanger and then leads to the cylinder so that the air flowing via this “hot channel” is heated, while the other air channel directly leads to the cylinder so that the air flowing via this “cold channel” is not preheated. Valves in the air channels may be operated to vary the inlet temperature by controlling the proportion of the air flow through the two channels, so that the gas mixture may start the self ignition near the top dead center (TDC) and the timing of the self ignition may be adjusted. As can be seen from the ignition control of the above 2 types of HCCI gasoline engine, temperature is very important to the ignition of HCCI engine.

Since the temperature and control over the temperature are very important to the HCCI, it is preferable that the HCCI gasoline engines run continuously to maintain the temperature level of the engine. However, engines on the HEVs often need to intermittently shut down temporarily to reduce gasoline consumption. This causes difficulties in applying the HCCI technology to the HEV.

### SUMMARY

Certain embodiments in the present disclosure solve the technical problem by providing an HCCI air intake system for HEV The air intake system enables the HCCI gasoline engine in the HEV to maintain an appropriate temperature level in the case of being shut off intermittently.

In order to solve the above technical problem, certain embodiments in the present disclosure include an HCCI air intake system for HEV, wherein:

the HEV comprises electrical drive system, HCCI gasoline engine, coolant heat exchanger, engine exhaust heat exchanger and a compressor, and

the air outlet of the compressor is simultaneously connected to a hot channel and a cold channel, the hot channel is connected to the cylinder of the HCCI gasoline engine via the electrical drive, coolant heat exchanger, engine exhaust heat exchanger and a throttle valve, while the cold channel is directly connected to the cylinder of the HCCI gasoline engine via another throttle valve.

Specifically, the electrical drive system comprises electrical motor and battery.

In one embodiment, the hot channel is connected to the cylinder of the HCCI gasoline engine via the electrical drive system, coolant heat exchanger, engine exhaust heat exchanger and a throttle valve sequentially.

As an improvement of the above technical solution, the hot channel is provided therein with at least one bypass valve for discharging air.

Further, a first bypass valve is provided at a position before the coolant heat exchanger and optionally as close as possible to the coolant heat exchanger.

Further, a second bypass valve is provided at a position after the engine exhaust heat exchanger.

The present disclosure provides a hot channel which may perform pre-heating on the engine by utilizing the heat generating components of the HEV, so that the HCCI gasoline engine maintains an appropriate temperature level in the case of being shut down intermittently. By controlling the proportion between the air intake of the hot channel and that of the other cold channel, the mean temperature of the air intake may be controlled, so that the gas mixture may start the self ignition near the top dead center (TDC) and the time of the self ignition may be adjusted. Certain embodiments of the present disclosure make the best use of the features of the electrical drive system and the HCCI gasoline engine in the HEV to make these two techniques combine and work with each other, thereby overcoming the difficulty in maintaining the temperature level caused by the fact that the HCCI gasoline engine in the HEV has to be shut down temporarily intermittently, and, on the other hand, enabling the HEV to adopt the relatively simple HCCI gasoline engine, and improving even further, with relatively lower cost, the fuel efficiency of the HEV.

Another aspect of the present disclosure is to provide a method for controlling the above air intake system, the specific solution of which is as follows:

First of all, with the throttle valve, the relative proportion between the two air flows entering the HCCI gasoline engine from the hot and cold channels, respectively, may be controlled, thereby ultimately controlling the mean intake air temperature to implement the control of the ignition.

In addition, in the above air intake system provided with a first bypass valve and a second bypass valve, opening/closing of those the bypass valves is controlled in accordance with the operation of the HEV and the control over the engine, thereby controlling the variation of the temperature of each segment in the channels with respect to time.

Specifically, after the engine is temporarily shut down, at the time before its hot startup, the second bypass valve is opened with the first bypass valve closed so as to fill up the air pipe with hot air rapidly.

Specifically, before the cold startup of the engine, all the bypass valves are closed to make the wall of the ignition chamber preheated by the hot air flowing in from the hot channel, before driving the engine to start with the electrical motor.

In the above air intake system, control is performed on the pressure of all the compressors to satisfy the requirement on the air intake pressure of the HCCI gasoline engine under various work conditions.

### BRIEF DESCRIPTION OF THE DRAWING

Next, the embodiments in present disclosure will be given a more detailed description with reference to the drawing.

FIG. 1 is the block diagram showing the configuration of the HCCI air intake system for HEV according to an aspect of the present disclosure.

Listed below are the reference numbers in the drawing:
1. compressor;
2. electrical drive system;
3. first bypass valve;
4. coolant heat exchanger;
5. engine exhaust heat exchanger;
6. throttle valve;
7. second bypass valve;
8. cylinder of the HCCI gasoline engine;
9. throttle valve.

### DETAILED DESCRIPTION OF THE EMBODIMENTS

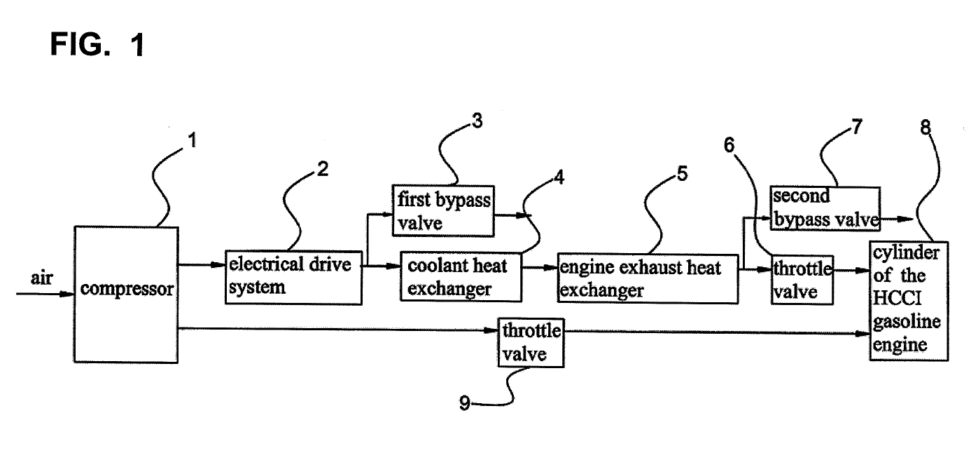

Generally, an HEV is driven by the electrical drive system together with the engine, wherein the electrical drive system, which comprises such electrical heat generating components as the electrical motor, battery, etc., often requires that a compressor to force air to circulate so as to cool down these heat generating components. According to the present disclosure, in the HEV to which the HCCI gasoline engine and the electrical motor are applied, the air circulation system required by the electrical drive system and the air intake system of the HCCI gasoline engine are designed as one system, the embodiment shown in FIG. 1, wherein air, after passing through the compressor 1, is bifurcated into two channels with one channel flowing through the electrical drive system 2 to absorb some heat before flowing through a coolant heat exchanger 4 to absorb part of the heat in the coolant and then flowing through the engine exhaust heat exchanger 5 to absorb part of the heat in the engine exhaust before finally entering the cylinder 8 of the HCCI gasoline engine, being the hot channel; and the other channel, along which no heating means is provided so that air from the intake pipe may enter the cylinder 8 of the engine directly, being the cold channel. The two channels are provided with a throttle valve 6, 9 respectively, which control the respective air flowing through the two channels, so as to control the relative proportion of the two flows of air, thereby controlling the mean temperature of the air entering the cylinder to ultimately implement the control of the ignition. In addition the air outlet pressure of the compressor of the HEV is controlled to satisfy the requirement on the air intake pressure of the HCCI gasoline engine under various operating conditions.

At least one bypass valve is provided downstream of the electrical drive system 2 in the hot channel so as to release the air in the channels into the atmosphere. This is to enable the engine to control, during its operation, the amount of air flowing through the electrical drive system, and to maintain, during the period in which the engine is shut down, the air flowing through the electrical drive system. In this embodiment, a first bypass valve 3 is provided at a position before the coolant heat exchanger 4 and optionally as close as possible to the coolant heat exchanger 4, so as to keep the air in the hot channel at a relatively high temperature level while preventing the air fluent from cooling down the coolant when the engine cuts off. Further, in order to speed up the engine's response at the time of its hot startup, a second bypass valve 7 is provided at a position after the engine exhaust heat exchanger 5 and optionally as close as possible to the air intake valve of the engine.

With the method for controlling the opening/closing of the above bypass valves 3 and 7, the variation of the temperature of each segment in the air channels with respect to time may be controlled in accordance with the operation of the HEV and the control over the engine. The above controlling method comprises the following steps: after the engine temporarily cuts off, at the time before its hot startup, the second bypass valve which is the closest to the engine is opened with the first bypass valve on the upstream side closed so as to fill up the hot channel with air rapidly; before the cold startup of the engine, all the bypass valves are closed to make the wall of the ignition chamber preheated by the hot air flowing in from the hot channel, before driving the engine to start with the electrical motor.

Certain embodiments in the present disclosure make the best use of the features of the electrical drive system and the HCCI gasoline engine in the HEV to make them combine and functionally complement each other, and provide an integrated air circulation system to meet the need to cool down the electrical drive system while controlling the air intake temperature of the engine cylinder, thereby overcoming the difficulty in maintaining the temperature level caused by the fact that the HCCI gasoline engine in the HEV has to be shut down intermittently. The air intake system and controlling method according to the present disclosure enable the HEV to adopt the relatively simple HCCI gasoline engine, thereby decreasing even further, with relatively lower cost, the mean gasoline consumption and exhaust discharge of vehicles.

What is claimed is:

1. An HCCI air intake system for HEV, wherein the HEV comprises an electrical drive system, an HCCI gasoline engine having a cylinder, a coolant heat exchanger, an engine exhaust heat exchanger and a compressor having an air outlet, the air intake system comprising:
a hot channel and a cold channel simultaneously connected to the air outlet of the compressor, the hot channel being connected to the cylinder of the HCCI gasoline engine via the electrical drive system, coolant heat exchanger, engine exhaust heat exchanger and a first throttle valve, and the cold channel being directly connected to the cylinder of the HCCI gasoline engine via a second throttle valve.

2. The HCCI air intake system for HEV according to claim 1, wherein the electrical drive system comprises electrical motor and battery.

3. The HCCI air intake system for HEV according to claim 1, wherein the hot channel is connected to the cylinder of the HCCI gasoline engine via the electrical drive system, coolant heat exchanger, engine exhaust heat exchanger and a throttle valve sequentially.

4. The HCCI air intake system for HEV according to claim 3, wherein the hot channel further comprises at least one bypass valve for discharging air into the ambient.

5. The HCCI air intake system for HEV according to claim 4, wherein the at least one bypass valve comprises a first bypass valve at a position of the hot channel before the coolant heat exchanger.

6. The HCCI air intake system for HEV according to claim 5, wherein the at least one bypass valve further comprises a second bypass valve at a position after the engine exhaust heat exchanger.

7. The HCCI air intake system for HEV according to claim 5, wherein the first bypass valve is positioned proximate the coolant heat exchanger.

8. A method for controlling the HCCI air intake system according to claim 1, wherein: with the first and second throttle valves, control a relative proportion between the two flows of air entering the HCCI gasoline engine respectively from the hot and cold channels, thereby controlling the mean temperature of the air intake finally to implement the control of ignition of the HCCI engine.

9. A method for controlling the HCCI air intake system according to claim 6, comprising controlling
the opening/closing of the bypass valves is controlled in accordance with the operation of the HEV and the control over the engine, thereby controlling the variation of the temperature of each segment in the channels with respect to time.

10. The controlling method according to claim 8, wherein after the engine is shut down temporarily, at the time before its hot startup, opening the second bypass valve with the first bypass valve closed so as to fill up the hot channel with hot air rapidly.

11. The controlling method according to claim 8, further comprising closing both the first and second bypass vales before a cold startup of the engine to make the wall of the ignition chamber preheated by the hot air flowing in from the hot channel, before driving the engine to start with the electrical drive system.

12. A method for controlling the HCCI air intake system according to claim 1, comprising controlling the pressure of the compressors according to a requirement on the air intake pressure of the HCCI gasoline engine under various work conditions.
